(19) United States
(12) Patent Application Publication
(10) Pub. No.: US 2008/0167979 A1
(43) Pub. Date: Jul. 10, 2008

(54) PROCESSES AND METHODOLOGIES FOR EQUITY STRUCTURES IN SHARED OWNERSHIP VENTURES

(75) Inventor: Daniel Somers, Mission Viejo, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: LAS VEGAS RESORT & GOLF VACATION HOMES, LLC

(21) Appl. No.: 11/845,581

(22) Filed: Aug. 27, 2007

Related U.S. Application Data
(60) Provisional application No. 60/883,964, filed on Jan. 8, 2007.

(51) Int. Cl. G06Q 50/00

(52) U.S. Cl. 705/35

(57) ABSTRACT

New methods for use of improved vehicles allowing preemption of traditional hotel and vacation resort models for fractional ownership are disclosed. According to the teachings of the instant disclosures, unmatched return on investment dollars coupled with choices of properties and locations allows provision of amenities that are unparalleled in both the resort hotel and high-end vacation club industries. Administrative and finance issues generally rendering such matters challenging are likewise ameliorated according to the instant teachings.

### RELATED APPLICATION

This application claims the benefit of and priority to U.S. Provisional Application Ser. No. 60/883,964, filed Jan. 8, 2006, the contents of which are incorporated by reference herein in its entirety.

### BACKGROUND

1. Field

The present disclosure relates to novel approaches to shared ownership generally and in particular to fields including real estate investment.

In particular, the present disclosure specifically provides an improved economic model to exploit procurement of high-end properties for real estate investors, owners, and those wishing to participate in an optimized and functionally useful vacation and real estate investment program. Methods for novel aspects of luxury resort ownership are likewise disclosed, along with products by these process, investment vehicles, and related services.

2. General Background

Existing systems for fractional ownership are fraught with numerous pitfalls. As a long term participant in these markets, the present inventor has spent his career as a student of extant systems and now offers for consideration improvements to the same. Holding equity in shared ownership is a long-felt need not adequately addressed prior to the advent of the instant teachings.

Real estate investments, and particularly those involved with acquiring properties with minimal investment, are often the goal of those skilled in these arts. However, taking the perspective of a professional realtor, and using ethical and visible mechanisms to accomplish this has not carried the day—prior to the advent of the instant teachings, which address and overcome these longstanding needs.

### SUMMARY

Briefly stated, novel enhanced methods for use of improved vehicles allowing preemption of traditional hotel and vacation resort models for fractional ownership are disclosed. According to the teachings of the instant disclosures, unmatched return on investment dollars coupled with choices of properties and locations allows provision of amenities that are unparalleled in both the resort hotel and high-end vacation club industries. Administrative and finance issues generally rendering such matters challenging are likewise ameliorated according to the instant teachings.

According to embodiments of the present disclosure, there is provided an improved process and methodology for providing equity in at least a property, which may include, in combination: procuring the at least a property with at least one of cash and loans; establishing a land trust for taking and recording title to the at least a property; providing at least one investor owner with an investor ownership of the land trust; and providing at least one equity owner with an equity ownership of the land trust. At least one of the investor ownership and the equity ownership may be defined by an operating agreement of the land trust. The equity ownership may include at least one of a right to realize a portion of an appreciation value of the at least a property, a right to receive a portion of an external income based on a rental of the at least a property, a right to use the at least a property, and a right to use an amenity associated with the at least a property. The improved process and methodology may further include the steps of: managing the at least a property of the land trust; and receiving at least one payment from at least one of the equity owner and the investor owner.

According to embodiments of the present disclosure, there is provided an improved real estate time-share related type of equity structure, which may include at least a property, a land trust, a property manager, an investor owner, and an equity owner. The property manager may manage the at least a property; the land trust may maintain title to the at least a property; the equity owner may hold equity ownership of the land trust; and the investor owner may hold investor ownership of the land trust.

According to embodiments of the present disclosure, there is provided a novel instrument for ownership of at least a property by way of a financial structure, which may include financial transfers between each of a land trust, a property manager, an investor owner, and an equity owner. The equity owner may provide an equity payment; the land trust may provide an external payment; an external income may be received by the land trust; the land trust may provide at least one of a mortgage payment and a late fee; the property manager may receive a property management fee. Further, the equity owner may benefit from a right to receive income from the at least a property and a right to use the at least a property.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram schematically illustrating an example of an equity structure, which may include a property, a land trust, a property manager, an investor owner, and an equity owner, according to embodiments of the present invention; and

FIG. 2 is a block diagram schematically illustrating an example of a financial structure, which may include financial transfers made between a land trust, a property manager, an investor owner, and an equity owner, according to embodiments of the present invention.

### DETAILED DESCRIPTION

The present inventor has discovered that for proper investor classes, granting actual ownership interests, or equity, can be well managed in an improved set of time-share types of ventures. The present inventor offers for consideration novel structures, including generating equity interests in real estate holdings hypothecated on a temporally fractionalized basis. A moderate investment of capital procures an equity stake, virtually risk free in terms of additional financial risk or otherwise foreseeable contingencies. Equity owners may benefit from the recommendation of experienced specialists in valuation, procurement, and management of selected properties.

Reference will now be made to embodiments, examples of which are illustrated in the accompanying drawings. While the invention will be described in conjunction with the preferred embodiments, it will be understood that these embodiments are not intended to limit the scope of the invention. On the contrary, the invention is intended to cover alternatives, modifications, and equivalents, which may be included within the spirit and scope of the invention as defined by the appended claims. As such, the descriptions of the embodiments that follow are for purposes of illustration and not limitation.

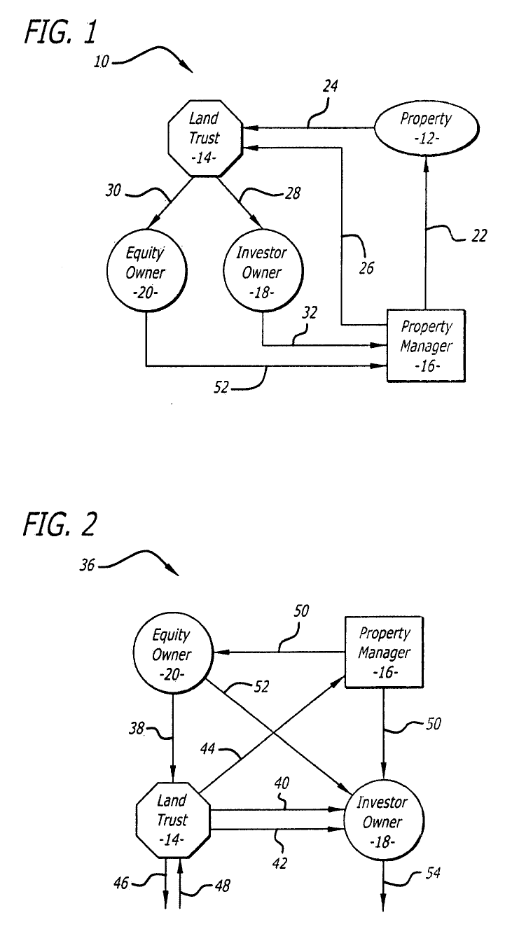

FIG. 1 is a block diagram schematically illustrating an example of equity structure 10, which may include property 12, land trust 14, property manager 16, investor owner 18, and equity owner 20, according embodiments of the present invention. According to embodiments, an improved process and methodology for providing equity in at least a property may include, in combination: procuring at least a property 12 with at least one of cash and loans; establishing land trust 14 for taking and recording title to at least a property 12; providing at least one investor owner 18 with investor ownership 28 of land trust 14; and providing at least one equity owner 20 with equity ownership 30 of land trust 14. At least one of investor ownership 28 and equity ownership 30 may be defined by an operating agreement of land trust 14. Equity ownership 30 may include at least one of a right to realize a portion of an appreciation value of at least a property 12, a right to receive a portion of an external income based on a rental of at least a property 12, a right to use at least a property 12, and a right to use an amenity associated with at least a property 12. The improved process and methodology may further include the steps of: managing at least a property 12 of land trust 14; and receiving at least one payment from at least one of equity owner 20 and investor owner 18.

Property manager 16 may procure property 12 in procurement 22. Property manager 16 may fund procurement 22 with at least one of cash and loans. Property 12 may include, but is not limited to, real property, a jet, a boat, a car, and a resort property such as a high value property, a desired geographic location, a luxurious villa, and other highly sought after vacation destinations.

According to embodiments, land trust 14 may be established, and title 24 to property 12 may be placed in land trust 14. For example, title 24 to property 12 may be taken and recorded by land trust 14. In at least an embodiment, property manager 16, as debtor, may enter into a mortgage agreement to procure property 12, and land trust 14 may assume the position of property manager 16 as debtor under the mortgage agreement and obtain title 24 to property 12. In at least an embodiment, land trust 14, as debtor, may obtain title 24 to property 12 by entering into a mortgage agreement with property manager 16, which may act as creditor.

According to embodiments, property manager 16 may procure a plurality of properties 12, wherein one land trust 14 may be established for each property 12. In at least an embodiment, manager 16 may procure a plurality of properties 12, wherein one land trust 14 may be established for the entire plurality of properties 12. Property manager 16 may manage property 12. For example, property manager 16 may be responsible for physical maintenance of property 12.

According to embodiments, investor owner 18 may be granted investor ownership 28 of land trust 14. For example, investor ownership 28 may include rights and duties under a mortgage agreement between land trust 14 and property manager 16, including the right to receive mortgage payments and late fees, which will later be discussed in more detail. Investor owner 18 may provide investor payment 32 to one or both of property manager 16 and land trust 14 as consideration for investor ownership 28. Investor owner 18 holding investor ownership 28 may also manage land trust 14. For example, investor ownership 28 may include rights and duties of managing the financial matters of land trust 14. In one embodiment, investor owner 18 may be a trustee of land trust 14.

According to embodiments, at least one equity owner 20 may be given equity ownership 30 of land trust 14. Equity ownership 30 may include a right to realize a portion of an appreciation value of property 12, a right to receive a portion of an external income based on a rental of property 12, a right to use property 12, and a right to use amenities associated with property 12. For example, the right to realize a portion of an appreciation value of property 12 may correspond to the size of equity ownership 30 in relation to other equity ownerships 30 and investor ownerships 28 of the same property 12. The right to use property 12 may include use of property 12 for a guaranteed minimum number of days in a year corresponding with the size of equity ownership 30 in relation to other equity ownerships 30 and investor ownerships 28 of the same property 12. In an embodiment, equity owner 20 may exchange the right to use property 12 in which it owns an interest for the use of another property 12 in which another equity owner 20 owns an interest. Amenities associated with property 12 may include, but are not limited to, a facility near property 12, a private butler, a jet, a boat, a car, and other features that may be enjoyed during use of property 12. In at least one embodiment, equity ownership 30 may include a guaranteed minimum income, wherein equity owner 20 receives at least a certain amount of income across a given period of time.

According to embodiments, equity ownership 30 may include rights and, duties defined by an operating agreement of land trust 14. For example, the operating agreement of land trust 14 may be modified to provide equity ownership 30 to equity owner 20 when equity owner 20 provides one or both of a down payment and at least one monthly payment to at least one of investor owner 18, property manager 16, and land trust 14. Investor owner 18 may initially hold all ownership rights to land trust 14, and investor owner 18 may distribute portions of its rights to land trust 14 in the form of equity ownership 30. For example, investor owner 18, having investor, ownership 28, may retain 20% ownership of land trust 14; eight equity owners 20, each having equity ownership 30, may each hold a 10% ownership of land trust 14. In one embodiment, equity owner 20 receives a deed corresponding to equity ownership 30.

According to embodiments, a referring equity owner 20 may receive a finder's fee based on a referral of one who becomes a new equity owner 20. For example, a referring equity owner 20 may be paid the value of up to 3% of the price of equity ownership 30 purchased by a new equity owner 20.

According to embodiments, one or more of land trust 12, property manager 16, equity owner 20, and investor owner 18 may be an entity that permits ownership by multiple parties. For example, investor owner 18 may be a stock-issuing entity such as, but not limited to, a limited liability company or a corporation. Property manager 16 may own a portion of the stock in investor owner 18. Another investor, such as an investor providing capital, may also own a portion of the stock in investor owner 18. In an embodiment, investor owner 18 may be a wholly-owned subsidiary of property manager 16. In at least an embodiment, investor owner 18 may be a partnership. For example, property manager 16 may be a partner in investor owner 18.

FIG. 2 is a block diagram schematically illustrating an example of financial structure 36, which may include financial transfers between land trust 14, property manager 16, investor owner 18, and equity owner 20, according to embodiments of the present invention. According to embodiments, each of land trust 14, property manager 16, investor owner 18, and equity owner 20 may maintain at least one bank account to receive and send the financial transfers.

According to embodiments, an improved real estate time-share related type of equity structure may include at least a property 12, land trust 14, property manager 16, investor owner 18, and equity owner 20. Property manager 16 may manage at least a property 12; land trust 14 may maintain title 24 to at least a property 12; equity owner 20 may hold equity ownership 30 of land trust 14; and investor owner 18 may hold investor ownership 28 of land trust 14.

According to embodiments, a novel instrument for ownership of at least a property 12 by way of a financial structure may include financial transfers between each of land trust 14, property manager 16, investor owner 18, and equity owner 20. Equity owner 20 may provide equity payment 38; land trust 14 may provide external payment 46; external income 48 may be received by at least one of land trust 14 and investor owner 18; land trust 14 may provide at least one of mortgage payment 40 and late fee 42; and property manager 16 may receive property management fee 44. Further, equity owner 20 may benefit from a right to receive income from at least a property 121 and a right to use at least a property 12.

According to embodiments, equity owner 20 may provide equity payment 38 to land trust 14. For example, equity payment 38 may include monthly payments. Equity owner 20 may provide down payment 52 to investor owner 18. In an embodiment, down payment 52 at least partially determines equity payment 38, wherein equity payment 38 may be lower based upon a larger down payment 52. For example, at least one of land trust 14, property manager 16, and investor owner 18 may provide equity owner 20 with private financing, wherein equity payment 38 may include payments required under such private financing. While the embodiment shown in FIG. 2 shows equity payment 38 paid to land trust 14 and down payment 52 paid to investor owner 18, it may be understood by those skilled in the art that equity payment 38 and down payment 52 may each be paid to one or more of land trust 14, property manager 16, and investor owner 18.

According to embodiments, land trust 14 may provide external payments 46. For example, external payments 46 may include taxes, insurance, home owner's association fees, and repair expenses associated with property 12. External income 48 may be received by land trust 14. External income 48 may include rental income and damage fees associated with property 12. For example, property 12 may be rented while not in use by equity owner 20 or investor owner 18 such that rental income and damage fees are collected from such rental of property 12. According to embodiments, land trust 14 may provide at least one of mortgage payment 40 and late fees 42 to investment owner 18 according to a mortgage agreement by which land trust 14 obtained title 24 to property 12.

According to embodiments, land trust 14 may provide property management fee 44 to property manager 16. For example, management fee 44 may include consideration in exchange for management 26 provided by property manager 16. In at least an embodiment, property management fee 44 may be paid to property manager 16 by one or more of land trust 14, investor owner 18, and equity owner 20.

According to embodiments, investor owner 18 may provide debt repayment 54 to meet the obligations of any loan used to fund procurement 22 of property 12. In at least an embodiment, one or both of land trust 14 and property manager 16 may provide debt repayment 54 to meet the obligations under any loan used to fund procurement 22 of property 12.

According to embodiments, property manager 16 may provide financial report 50 on behalf of land trust 14 to at least one of land trust 14, investor owner 18, and equity owner 20. For example, financial report 50 may include information regarding at least one of management 26 provided by property manager 16, external payments 46, external income 48, and any other information relevant to property 12 or land trust 14. Where equity owner 20 makes equity payments 38, financial report 50 contains information demonstrating to equity owner 20 that equity payments 38 are being used to provide debt repayment 54 to meet the obligations of any loan used to fund procurement 22 of property 12 and to maintain title 24 to property 12.

According to embodiments, the financial structure may include financial benefits from a tax structure. For example, the tax structure may include the ability of at least one of equity owner 20 and investor owner 18 to treat equity ownership 30 or investor ownership 28, respectively, as capital gains. The tax structure may also include the ability to establish one or more of land trust 12, property manager 16, equity owner 20, and investor owner 18 as an entity that receives beneficial tax treatment, such as, but not limited to, a partnership, an S-corporation, a limited-liability company, or any other entity that receives beneficial tax treatment.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An improved process and methodology for providing equity in at least a property, which comprises, in combination:
procuring said at least a property with at least one of cash and loans;
establishing a land trust for taking and recording title to said at least a property;
providing at least one investor owner with an investor ownership of said land trust; and
providing at least one equity owner with an equity ownership of said land trust.

2. The improved process and methodology of claim 1, wherein at least one of said investor ownership and said equity ownership is defined by an operating agreement of said land trust.

3. The improved process and methodology of claim 1, wherein said equity ownership comprises at least one of a right to realize a portion of an appreciation value of said at least a property, a right to receive a portion of an external income based on a rental of said at least a property, a right to use said at least a property, and a right to use an amenity associated with said at least a property.

4. The improved process and methodology of claim 3, wherein one of said at least one equity owner may exchange said right to use said at least a property for a right to use a second at least a property subject to a second equity ownership by a second equity owner.

5. The improved process and methodology of claim 1, wherein said investor owner is a trustee of said land trust.

6. The improved process and methodology of claim 1, further comprising said steps of:
managing said at least a property of said land trust; and
receiving at least one payment from at least one of said equity owner and said investor owner.

7. An improved real estate time-share related type of equity structure, comprising at least a property, a land trust, a property manager, an investor owner, and an equity owner, wherein:
said property manager manages said at least a property;
said land trust maintains title to said at least a property;
said equity owner holds equity ownership of said land trust; and
said investor owner holds investor ownership of said land trust.

8. The improved real estate time-share related type of equity structure of claim 7, wherein
said equity owner provides an equity payment;
said land trust provides an external payment;
an external income is received by at least one of said land trust and said investor owner;
said land trust provides at least one of a mortgage payment and a late fee; and
said property manager may receive a property management fee.

9. A novel instrument for ownership of at least a property by way of a financial structure, comprising financial transfers between each of a land trust, a property manager, an investor owner, and an equity owner, wherein:
said equity owner provides an equity payment;
said land trust provides an external payment;
an external income is received by at least one of said land trust and said investor owner;
said land trust provides at least one of a mortgage payment and a late fee; and
said property manager may receive a property management fee.

10. The novel instrument of claim 9, wherein said at least a property is a real estate property.

11. The novel instrument of claim 9, wherein said equity owner benefits from a right to receive income from said at least a property and a right to use said at least a property.

12. The novel instrument of claim 9, wherein said financial structure comprises financial benefits from a tax structure.

13. The novel instrument of claim 9, wherein said tax structure comprises an ability to treat said at least a property as capital gains.

14. The novel instrument of claim 9, wherein said equity owner provides a down payment to said investor owner.

15. The novel instrument of claim 9, wherein said property manager provides a financial report to at least one of said equity owner and said investor owner.

16. The novel instrument of claim 9, wherein at least one of said investor owner and said land trust provides a debt repayment to meet an obligation under a loan used to fund a procurement of a property.
